(19) United States
(12) Patent Application Publication
(10) Pub. No.: US 2012/0270611 A1
(43) Pub. Date: Oct. 25, 2012

(54) METHOD FOR CONTROLLING MOBILE TERMINAL

(75) Inventors: Kwang-Seong CHOI, Bucheon-si (KR); Ki-Hong IM, Suwon-si (KR); Kyoung-Yong LEE, Suwon-si (KR)

(73) Assignee: Samsung Electronics Co., Ltd., Suwon-si (KR)

(21) Appl. No.: 13/451,073

(22) Filed: Apr. 19, 2012

Related U.S. Application Data
(60) Provisional application No. 61/477,012, filed on Apr. 19, 2011.

(51) Int. Cl. H04W 52/02

(52) U.S. Cl. 455/574

(57) ABSTRACT

A method for controlling a mobile terminal is provided. The method includes obtaining operation mode switching information made by a sensor, and determining whether an operation mode switching condition of the mobile terminal is satisfied based on the information; and switching an operation mode of the mobile terminal, if the switching condition is satisfied, wherein obtaining and switching are performed by an application that invokes and uses an Application Programming Interface (API).

### PRIORITY

This application claims priority under 35 U.S.C. §119 to a U.S. patent application filed in the United States Patent and Trademark Office on Apr. 19, 2011 and assigned Ser. No. 61/477,012, the entire disclosure of which is incorporated herein by reference.

### BACKGROUND OF THE INVENTION

1. Field of the Invention

The present invention relates generally to a mobile terminal, and more particularly, to a method for controlling a mobile terminal.

2. Description of the Related Art

With the increase in size and resolution of display units (e.g., Organic Light Emitting Diode (OLED) or Liquid Crystal Display (LCD)), along with the enhancement of hardware performance such as adoption of multi-core controllers (e.g., multi-core Central Processing Unit (CPU) or multi-core Graphics Processing Unit (GPU)), power consumption of mobile terminals has been increasing.

To solve these problems, methods have been provided to reduce power consumption in mobile terminals.

For example, mobile terminals equipped with various sensors (e.g., a proximity sensor), switch the operation mode between a sleep mode and a wake-up mode depending on various conditions detected by such sensors.

As another example, even though a certain sensor in a mobile terminal is in operation, if sleep mode entry conditions are satisfied, the mobile terminal enters sleep mode and most of the components (or modules) of the mobile terminal, including that sensor, are disabled, to reduce battery consumption.

As a further example, when a certain sensor is in operation, a mobile terminal does not enter sleep mode, only the display of the mobile terminal is disabled, and the sensor continues its operation.

In these conventional methods, whether or not a sensor is operating is not considered when a mobile terminal enters sleep mode, and after entering sleep mode, the mobile terminal does not switch its operation mode depending on the operation of the sensor, thus limiting its functionality and reducing its battery efficiency.

Switching between sleep mode and wake-up mode may be achieved by an application that provides a mode switching function. However, a switch designed to run on a specific platform may not operate on all mobile terminals operating with the same platform. The low-compatibility problem of applications is caused by the fragmentation of the platform. For example, in the case of Android®, due to the fragmentation, all Android applications may not operate in some Android mobile terminals.

### SUMMARY OF THE INVENTION

An aspect of the present invention is to provide a method for providing a function of switching an operation mode of a mobile terminal in sleep mode and wake-up mode depending on the operating status and/or detection result of a sensor, by means of an application, and ensuring compatibility of the application.

In accordance with one aspect of the present invention, a method for controlling a mobile terminal is provided. The method includes obtaining operation mode switching information made by a sensor; determining whether an operation mode switching condition of the mobile terminal is satisfied based on the information; and switching an operation mode of the mobile terminal, if the switching condition is satisfied, wherein obtaining and switching are performed by an application that invokes and uses an Application Programming Interface (API).

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 illustrates a schematic block diagram of a mobile terminal according to an embodiment of the present invention;

FIG. 2 illustrates a table according to an embodiment of the present invention; and

FIG. 3 illustrates a process of controlling a mobile terminal by switching an operation mode according to an embodiment of the present invention.

### DETAILED DESCRIPTION OF EMBODIMENTS OF THE PRESENT INVENTION

Embodiments of the present invention will now be described in detail with reference to the accompanying drawings. In the following description, specific details such as detailed configuration and components are merely provided to assist with the overall understanding of embodiments of the present invention. Thus, it should be apparent to those skilled in the art that various changes and modifications of the embodiments described herein can be made without departing from the scope and spirit of the invention. Additionally, descriptions of well-known functions and constructions are omitted for clarity and conciseness.

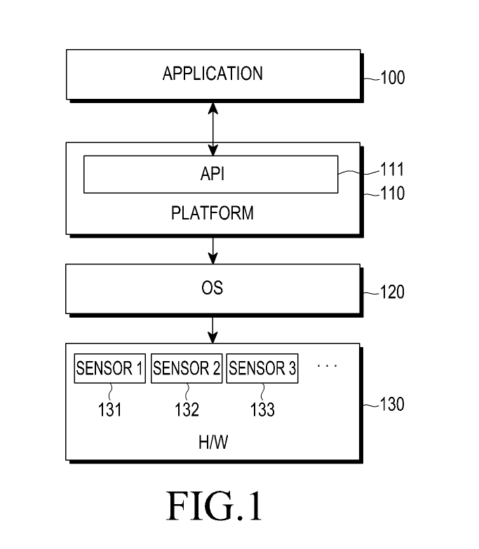

FIG. 1 illustrates a schematic block diagram of a mobile terminal according to an embodiment of the present invention.

Referring to FIG. 1, an application 100, an application program running on its associated platform 110, is downloaded and installed online or offline.

In an embodiment of the present invention, the application 100 invokes an Application Programming Interface (API) 111 of the platform 110 to obtain operation mode switching information, for switching of an operation mode of the mobile terminal. In response, the platform 110 obtains operation mode switching information from an Operating System (OS) 120, and provides the information to the application 100.

Furthermore, the application 100 invokes the API 111 of the platform 110 to change setting information for operation mode switching. In response, the platform 110 obtains setting information for operation mode switching from the OS 120, and transfers the setting information to the application 100. The application 100 then displays the obtained setting information for operation mode switching, update the setting information according to the user's request to change the settings, and transfer the updated setting information to the OS 120 through the platform 110 and the API 111.

The platform 110 is system architecture for mobile terminals, provided to allow many different types of applications to run thereon, such as Google's Android®, Apple's iOS®, and Samsung's Bada®. The platform 110 includes one or more APIs. An API is a set of functions invoked and used by applications. An application developed to use an API on the platform 110 is guaranteed to operate in any mobile terminals equipped with the same platform 110, improving the compatibility of the application.

In accordance with an embodiment of the present invention, the platform 110 includes one or more APIs 111 used by the application 100 that uses a sensor(s) to switch an operation mode of the mobile terminal. When invoked by the application 100, the platform 110 runs the API 111, which is an API that switches an operation mode of the mobile terminal using a sensor.

The API 111 provides operation mode switching information to the application 100 so that the application 100 switches an operation mode of the mobile terminal using a sensor.

The operation mode switching information includes information indicating whether an operation mode switching function is supported for sensors 131 to 133 included in the mobile terminal, information indicating whether the operation mode switching is enabled, reference data based on which an operation mode for each of the sensors is switched, and sensor data from the sensors.

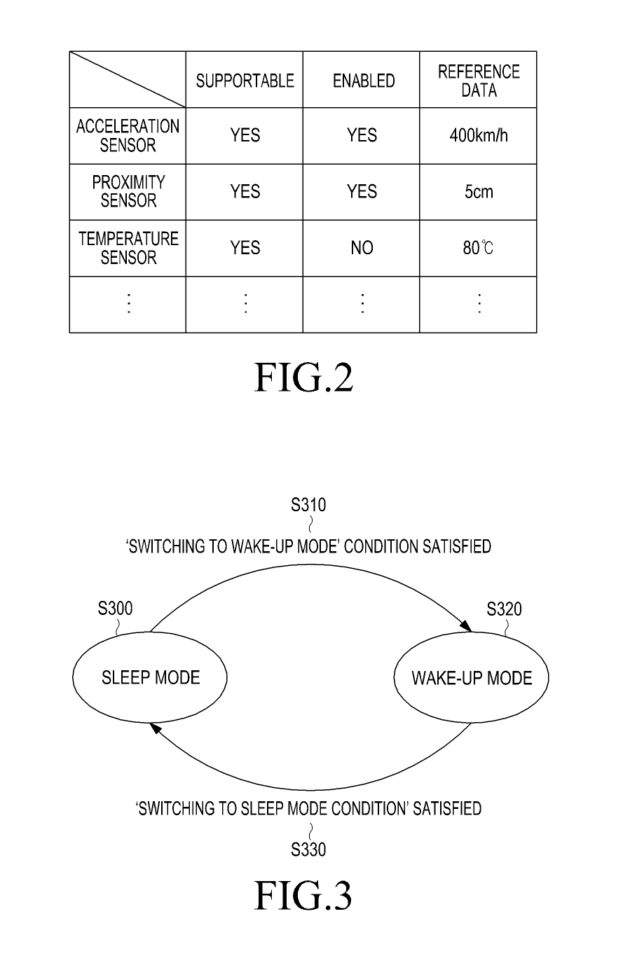

Referring to FIG. 2, assuming that the mobile terminal includes an acceleration sensor, a proximity sensor and a temperature sensor, by obtaining information related to an operation mode switching function, an application determines that the operation mode of the mobile terminal is switched to a sleep mode (e.g., airplane mode) and checks the current speed of the mobile terminal, if the operation mode switching function based on the acceleration sensor is supported and enabled, and if the speed of the mobile terminal is 400 km per hour or more. The application determines that the operation mode of the mobile terminal is switched to a sleep mode (e.g., in which the display is disabled) and detects the presence of nearby objects, if the operation mode switching function based on the proximity sensor is supportable and enabled presently, and if the object approaches the proximity sensor within a predetermined distance (e.g., close distance of 5 cm or less). The application determines that the operation mode of the mobile terminal is switched to a sleep mode and determines that the current temperature is 40° C., if the operation mode switching function based on the temperature sensor is supportable but disabled presently, and if a temperature of 80° C. is sensed by the temperature sensor to prevent the mobile terminal from malfunctioning.

According to the foregoing description, in the case in which a predetermined application enters sleep mode if the speed of the mobile terminal is higher than a predetermined speed, the application invokes the API 111 and switches the operation mode of the mobile terminal between the make-up mode and the sleep mode depending on the speed of the mobile terminal, using a sensor (e.g., an acceleration sensor).

The API 111 provides setting information for operation mode switching of the mobile terminal to an application. By obtaining setting information for operation mode switching, an application changes settings for operation mode switching, by changing information indicating whether an operation mode switching function is supportable for each sensor, information indicating whether operation mode switching is enabled, and reference data based on which operation mode is switched. For example, upon a user's request after obtaining setting information for operation mode switching of the mobile terminal, an application changes the settings to enable the operation mode switching function based on the temperature sensor, which was disabled in the description made with reference to FIG. 2. Thus, based on the setting information for operation mode switching of the mobile terminal, which the application obtains by using the API 111, the user sets information indicating whether sensor-based operation mode switching is enabled (e.g., whether to use a sensor for operation mode switching of the mobile terminal), for each sensor.

It is assumed that the API 111 is a public API that is open to the public or application developers. Based on this assumption, the application developers freely develop applications using the API 111, and the developed applications are widely used in all mobile terminals operating with their associated platform 110.

The platform 110 is assumed to be Samsung's Bada®.

The OS 120 is an Operating System (OS) of the mobile terminal. Although there are many different types of OSs, the OS 120 is assumed to be Nucleus OS, which is a type of Real Time OS (RTOS).

Hardware (H/W) 130 represents hardware configurations of the mobile terminal.

In accordance with an embodiment of the present invention, the hardware 130 includes one or more sensors: sensor #1 131, sensor #2 132 and sensor #3 133. It will be understood by those of ordinary skill in the art that the number of sensors is not limited to 3.

Sensors #1 to #3 may be used for operation mode switching of the mobile terminal, and may include an acceleration sensor, a geomagnetic sensor, a gyro sensor, a proximity sensor, a distance measurement sensor, a temperature sensor, and a moisture sensor. Sensors #1 to #3 are controlled by their associated drivers included in the OS 120.

Although not illustrated, the hardware 130 provides several devices mounted on the mobile terminal and providing their associated functions. For example, the hardware 130 includes a wireless transceiver for providing communication features, a multimedia processor for processing audio/video data, a key input unit capable of inputting user inputs, a memory for storing various data, a battery for supplying electric power to the mobile terminal, a display for receiving user input including display data on a touchscreen, and a controller for controlling the overall operation of the mobile terminal.

Examples of the mobile terminal includes videophones, feature phones, smart phones, Personal Digital Assistants (PDAs), Portable Multimedia Players (PMPs), Digital Multimedia Broadcasting (DMB) terminals, E-Book terminals, tablet computers, and the like.

FIG. 3 illustrates a process of controlling a mobile terminal by switching an operation mode according to an embodiment of the present invention.

In steps S300 to S320, an application determines whether the mobile terminal operating in the sleep mode satisfies the “switching to wake-up mode” conditions. If the conditions are satisfied, the application switches the operation mode of the mobile terminal to the wake-up mode, and waits for user input in wake-up mode.

In accordance with an embodiment of the present invention, the application 100 invokes the API 111, and the platform 110 obtains the above-described operation mode switching information from the OS 120 by running the API 111.

By obtaining the operation mode switching information, the application 100 determines whether conditions for switching the operation mode of the mobile terminal from sleep mode to wake-up mode are satisfied, and switches the operation mode of the mobile terminal to wake-up mode if the conditions are satisfied.

Referring to FIGS. 1 and 2, for example, as a result of checking the obtained operation mode switching information, if the mobile terminal is within 5 cm of another object, sensor #2 (e.g., proximity sensor) detects the proximity, the mode switching function and is enabled, the application 100 switches the operation mode of the mobile terminal to the wake-up mode.

In step 330, the application 100 switches from wake-up mode to sleep mode if THE “switching to sleep mode” conditions are satisfied.

The application 100 may obtain operation mode switching information associated with sensors 131, 132 and 133 through the platform 110, the API 111 and the OS 120, and based thereon, determine to switch to the sleep mode.

For example, assuming that sensor #1 131 is an acceleration sensor and the operation mode switching information as shown in FIG. 2 is obtained, the application 100 switches the operation mode of the mobile terminal to the sleep mode, if the speed of the mobile terminal exceeds 400 Km per hour in the state in which the mobile terminal is in the wake-up mode as the speed of the mobile terminal is less than 400 Km per hour.

As another example, the application 100 requests to switch the operation mode of the mobile terminal to sleep mode (e.g., in which the display is turned off) if there is no input (key input or touch input) from the user for a predetermined period of time in the state in which the display of the mobile terminal is turned on.

As is apparent from the foregoing description, the present invention switches the operation mode of the mobile terminal by means of an application using a public API, thereby reducing battery consumption and increasing the compatibility of the application capable of switching the operation mode of the mobile terminal.

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for controlling an operation mode of a mobile terminal, the method comprising:
obtaining operation mode switching information made by a sensor;
determining whether an operation mode switching condition of the mobile terminal is satisfied based on the operation mode switching information; and
switching the operation mode of the mobile terminal, if the switching condition is satisfied.

2. The method of claim 1, wherein obtaining and switching are performed by an application that invokes and uses an Application Programming Interface (API).

3. The method of claim 2, wherein the operation mode switching information is obtained by using a platform and an Operating System (OS), and the API is a public API of the platform.

4. The method of claim 1, wherein switching comprises switching the operation mode of the mobile terminal from a wake-up mode to a sleep mode if a condition is satisfied.

5. The method of claim 1, wherein switching comprises switching the operation mode of the mobile terminal from a sleep mode to a wake-up mode if a condition is satisfied.

6. The method of claim 1, wherein the sensor includes at least one of an acceleration sensor, a geomagnetic sensor, a gyro sensor, a proximity sensor, a distance measurement sensor, a temperature sensor, and a humidity sensor.

7. The method of claim 1, wherein the operation mode switching information includes information indicating whether the operation mode switching is supportable for the sensor in the mobile terminal, information indicating whether the operation mode switching is enabled, reference data based on whether an operation mode for the sensor is switched, and sensor data from the sensor.
